(19) United States
(12) Patent Application Publication
(10) Pub. No.: US 2020/0198679 A1
(43) Pub. Date: Jun. 25, 2020

(54) CART POWER SUPPLY EQUIPMENT AND CART STORAGE SYSTEM

(71) Applicant: TOSHIBA TEC KABUSHIKI KAISHA, Tokyo (JP)

(72) Inventor: Takuya OGISHIMA, Izu Shizuoka (JP)

(21) Appl. No.: 16/570,051

(22) Filed: Sep. 13, 2019

(30) Foreign Application Priority Data
Dec. 21, 2018 (JP) 2018-239070

(51) Int. Cl. B62B 3/14; H02J 7/02; H02J 50/10; H02J 50/40; H02J 50/90

(52) U.S. Cl. CPC B62B 3/1404; H02J 7/025; B62B 3/1408; H02J 50/40; H02J 50/90; H02J 50/10

(57) ABSTRACT

A cart power supply equipment includes a frame providing a cart storage region, a guide including an uphill slope portion having an uphill slope along a cart guide direction to the cart storage region and a downhill slope portion having a downhill slope in the cart guide direction, the downhill slope portion being downstream of the uphill slope portion along the cart guide direction, a first stopper configured to stop a cart at a stop position on the downhill slope portion of the guide, a detector configured to detect that the cart is at the stop position, a power transmitter configured to transmit power for charging in a non-contact manner, and a controller configured to control the power transmitter to start transmitting the power when the detector detects that the cart is at the stop position.

### CROSS-REFERENCE TO RELATED APPLICATION

This application is based upon and claims the benefit of priority from Japanese Patent Application No. 2018-239070, filed Dec. 21, 2018, the entire contents of which are incorporated herein by reference.

### FIELD

Embodiments described herein relate generally to a cart power supply equipment and a cart storage system with a wireless rechargeable power receiver.

### BACKGROUND

In recent years, a shopping cart that has a display screen for displaying product information or the like has been widely used. Such a cart includes a battery as a power source used for the display unit . In addition, there is a cart power supply equipment that operates to charge a cart battery in a non-contact, wireless manner.

This cart power supply equipment includes a power transmitter within a frame in which the cart including a power receiver is to be parked, and when the cart is guided into position by a guide of the frame to a charging position, the battery in the cart is charged by electromagnetic induction. Accordingly, a user can charge the cart battery simply by storing the cart in the frame with the cart power supply equipment.

However, the cart may not necessarily be stored at an appropriate position, and as a result of being randomly placed by users, the cart may be left at a position away from the charging position . In such a case, charging may not be properly started or the battery charging efficiency may deteriorate.

### DESCRIPTION OF THE DRAWINGS

FIG. 1 illustrates a perspective view of a cart power supply equipment and a cart according to an embodiment.

FIG. 2 illustrates a top plan view of the cart power supply equipment according to the embodiment.

FIGS. 3A and 3B illustrate side plan views of a slope of the cart power supply equipment according to the embodiment.

FIG. 4 illustrates a side plan view of a power transmitter of the cart power supply equipment according to the embodiment.

FIG. 5 illustrates a perspective view of a cart according to the embodiment.

FIG. 6 illustrates a side plan view of the cart power supply equipment and the cart according to the embodiment.

FIG. 7 is a block diagram illustrating a hardware configuration of the cart power supply equipment according to the embodiment.

FIG. 8 is a block diagram illustrating a hardware configuration of the cart according to the embodiment.

FIG. 9 is a control flowchart of non-contact charging according to the embodiment.

FIG. 10 illustrates a side plan view of a cart power supply equipment according to a second embodiment.

FIGS. 11A to 11C illustrate side plan views of the cart power supply equipment and one or more carts according to the second embodiment.

### DETAILED DESCRIPTION

Embodiments provide a cart power supply equipment capable of stopping a cart at a position where a power receiver of the cart and a power transmitter of the cart power supply equipment face each other.

In general, according to an embodiment, a cart power supply equipment includes a frame providing a cart storage region, a guide including an uphill slope having an uphill slope along a cart guide direction to the cart storage region and a downhill slope having a downhill slope in the cart guide direction, the downhill slope being downstream of the uphill slope along the cart guide direction, a first stopper configured to stop a cart at a stop position on the downhill slope of the guide, a detector configured to detect that the cart is at the stop position, a power transmitter configured to transmit power for charging in a non-contact manner, and a controller configured to control the power transmitter to start transmitting the power when the detector detects that the cart is at the stop position.

Hereinafter, embodiments will be described with reference to the drawings.

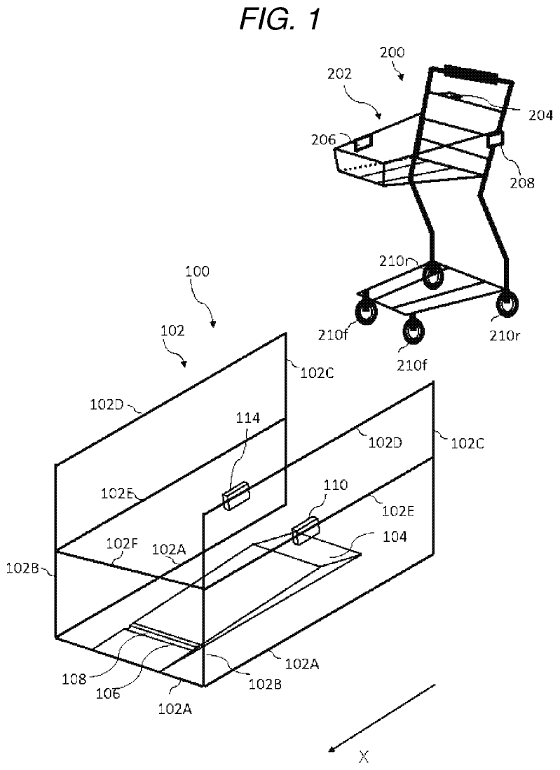

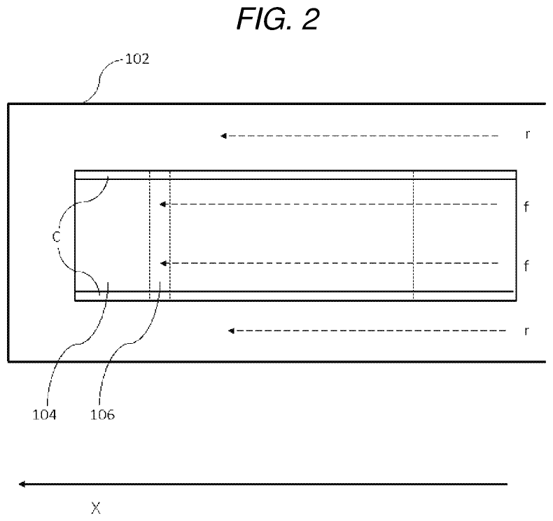

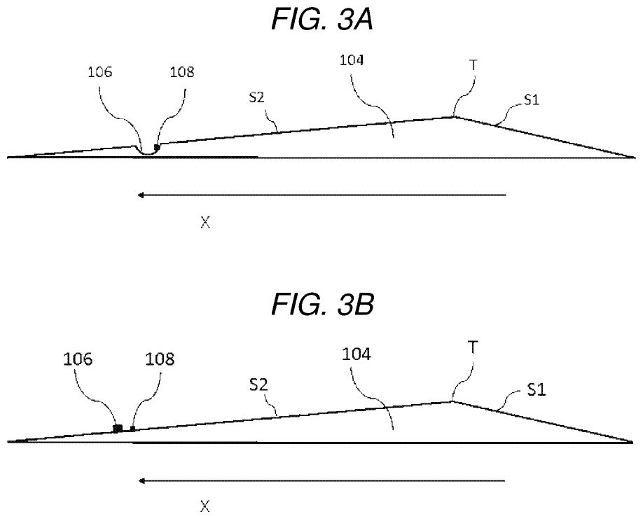

FIG. 1 illustrates a perspective view of a cart power supply equipment 100 and a cart 200 according to a first embodiment. FIG. 2 illustrates a top plan view of the cart power supply equipment 100. FIGS. 3A and 3B illustrate side plan views of a slope 104 of the cart power supply equipment 100. Hereinafter, description will be made with reference to FIGS. 1 to 3B.

The cart power supply equipment 100 is provided at a facility, such as a supermarket or a shopping mall, or in a parking lot. The cart power supply equipment 100 stores and charges the cart 200, which can be used for shopping and the like. The cart power supply equipment 100 includes a frame 102, a slope 104, a stopper 106, a detector 108, a power transmitter 110, and a controller 114. The cart 200 includes a carriage part 202, a display 204, a battery 206, a power receiver 208, and wheels 210. In the drawings, an arrow X indicates an advancing direction of the cart 200 when the cart 200 is stored in the cart power supply equipment 100. The advancing direction in these examples corresponds to the primarily forward direction of the cart 200 when pushed by a user/operator.

The frame 102 forms an outer frame of the cart power supply equipment 100. In other words, the frame 102 functions as a parking frame. The frame 102 has bottom side frame 102A. In FIG. 1, three bottom side frames 102A are provided in a U-shape on the floor surface side. In addition, two support units 102B, which are vertical to the floor and each have one end which is connected to one end of a bottom side frame 102A. There are support units 102C, which are perpendicular to the floor and each have one end is connected to an end of a bottom side frame 102A. Further, the frame 102 has two upper frames 102D to connect ends of the support units 102B and the support units 102C. In addition, two middle frames 102E are provided so as to connect between the support units 102B and the support units 102C. A back frame 102F is provided so as to connect between the two support units 102B.

This particular frame 102 configuration is one example and frame 102 configurations are not limited to this example. For example, the arrangement of the bottom side frames 102A may be configured to have a C shape instead of a U shape and extend the middle frame 102E and the upper frame 102D in the same direction as the bottom side frame 102A. Further, the number of members that configure the frame 102 may be increased as appropriate.

The slope 104 is a guide for guiding the wheels 210 of the cart 200 stored in the frame 102. FIG. 2 illustrates a top plan view of the cart power supply equipment 100. In FIG. 2, the trajectory through which a front wheel 210f of the cart 200 passes is indicated by a dotted arrow f, and the trajectory through which a rear wheel 210r passes is indicated by a dotted arrow r. A width of the slope 104 is wider than a width of the front wheel 210f of the cart 200, and regarding the size, for example, when the width of the front wheel 210f is 20 cm, the width of the slope 104 is approximately 40 cm. The width of the slope 104 is narrower than the width of the rear wheel 210r of the cart 200. With this configuration, the slope 104 causes the front wheel 210f to advance on the slope 104, and causes the rear wheel 200r to advance on both sides of the slope 104. In addition, derailment preventing covers C (which may also be referred to as a cart wheel guide) may be provided on both sides of the slope 104 such that each front wheel 210f does not derail as it advances on the slope 104. The derailment preventing cover C is a projection portion having a height of, for example, approximately 2 cm, and prevents the front wheel 210f from falling from the slope 104. The derailment preventing cover C may be integrally formed on the slope 104 or may be attached to the slope 104 by an adhesive or other attaching means.

As illustrated in FIGS. 3A and 3B, the slope 104 has a first slope S1, a vertex T, and a second slope S2. When the cart 200 is stored in the cart power supply equipment 100, the first slope S1 has a slope that is an uphill slope with respect to the floor face on which the cart power supply equipment 100 is installed. When the cart 200 is stored in the cart power supply equipment 100, the second slope S2 has a slope that is a downhill slope toward the floor face from the end portion (corresponding to the vertex T) on a side that is not in contact with the floor face of the first slope S1. When the cart 200 advances on the slope 104, the front wheel 210f climbs the first slope 51 along the advancing direction X of the cart 200, passes through the vertex T, and descends the second slope S2. In addition, it is desirable that the slope of the first slope S1 has an angle steeper than the slope of the second slope S2.

The stopper 106 is a stopper (e.g., bump) for stopping the cart 200 guided on the slope 104. The stopper 106 is a recess portion provided in the slope 104 as illustrated in FIG. 3A, and the cart 200 is stopped at the charging position as the front wheel 210f of the cart 200 is fitted into the recess portion. The charging position is a position of the cart 200 where the power transmitter 110 and the power receiver 208, which will be described below, are disposed to face each other.

In addition, the configuration of the stopper 106 is not limited thereto. The stopper 106 may be a unit that can stop the advance of the cart 200, and for example, may be a projected stopper as illustrated to FIG. 3B. The projected stopper may be integrally formed with the slope 104 or may be attached to the slope 104 by an adhesive or the like.

The detector 108 is a sensor for detecting that the cart 200 is at the charging position. For example, as illustrated in FIGS. 3A and 3B, the detector 108 is configured with a mechanical switch provided in the stopper 106. When the mechanical switch is pressed by the front wheel 210f of the cart 200, the detector 108 detects that the cart 200 is at the charging position. In addition, the detector 108 of the embodiment is provided in the width direction of the slope 104 along the stopper 106 as illustrated in FIG. 1. Accordingly, when the front wheel 210f is stopped by the stopper 106, the detector 108 can detect the cart 200 regardless of the deviation in the direction orthogonal to the X direction that is the advancing direction of the cart 200.

In addition, the configuration of the detector 108 is not limited thereto. For example, an optical sensor having a light emitting unit and a light receiving unit instead of the mechanical switch may be employed. When using the optical sensor, the light emitting unit and the light receiving unit are disposed so as to face each other at a position sandwiching the front wheel 210f via the slope 104. When the cart 200 stops at the charging position, the front wheel 210f enters between the light emitting unit and the light receiving unit, and the light emitted from the light emitting unit is not received by the light receiving unit. Accordingly, it is possible to detect that the cart 200 is at the charging position. In addition, as another aspect, the light emitting unit and the light receiving unit may be disposed on the same side with respect to the slope 104. In this case, the light emitted from the light emitting unit is reflected by the front wheel 210f of the cart 200 attached to the charging position, the reflected light is received by the light receiving unit, and accordingly, the cart 200 is detected. In addition, the position of the detector 108 is not limited to the description above. For example, when a mechanical switch is used, the rear wheel 210r may be detected, and when an optical sensor is used, the battery 206, the display 204, or other configurations of the cart 200 stopped at the charging position may be detected.

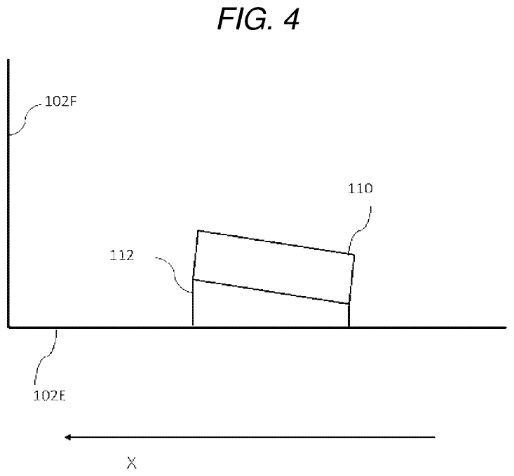

The power transmitter 110 performs non-contact charging with the power receiver 208 provided in the cart 200, which will be described further below. The position of the power transmitter 110 faces the power receiver 208 when the cart 200 stops at the charging position. FIG. 4 illustrates a side plan view of the power transmitter 110 and an attachment 112. As illustrated in FIG. 4, it is desirable that the attachment 112 is provided between the power transmitter 110 and the frame 102. The attachment 112 is a base having a trapezoidal shape, and can have an angle oriented toward the power transmitter 110 such that the power transmitter 110 is likely to face the power receiver 208 attached to the cart 200.

When the detector 108 detects that the cart 200 has stopped, the controller 114 executes processing of the non-contact charging. Details of charge control of the controller 114 will be described below.

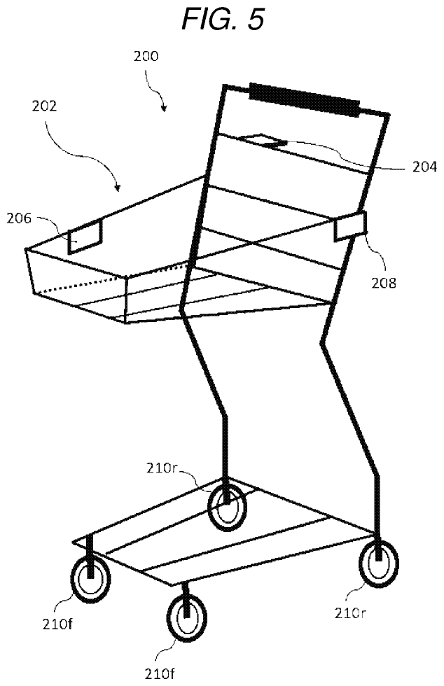

FIG. 5 illustrates a perspective view of the cart 200 having the power receiver 208. The cart 200 according to the present embodiment includes the carrier part 202, the display 204, the battery 206, the power receiver 208, and the wheels 210.

The carrier part 202 is a storage part for a customer to store a product or the like or to place a shopping basket.

The display 204 includes a display screen, such as a liquid crystal display or an organic EL (Electro Luminescence) display. The display 204 displays product information and the like, such as the price of a product placed on the carrier part 202 by the customer. The display 204 is supplied with electric power from the battery 206. In addition, a personal information terminal (e.g., a tablet computer) or the like in which an application is installed can be used as the display 204.

The battery 206 is a power source for supplying the electric power to the display 204. The battery 206 is charged by power supplied from the power receiver 208 which will be further described below. The battery 206 of this embodiment is provided separately from the power receiver 208, but may instead or in addition be provided in or otherwise integrated with the power receiver 208.

The power receiver 208 is a device that generates electric power from the non-contact power supplied by the power transmitter 110 of the cart power supply equipment 100, and charges the battery 206. The power receiver 208 is provided on the side surface of the cart 200 such that the power receiving side is disposed to face the power transmitter 110. Here, the power receiver 208 is provided on the face of the carriage part 202 side, but the installed height may be any position as long as the power receiver 208 can be disposed to face the power transmitter 110. The description of charging by the power receiver 208 will be described below.

The wheels 210 enable movement of the cart 200. The cart 200 has wheels 210, which include in this example a left front wheel, a right front wheel, a left rear wheel, and a right rear wheel. For convenience of description, the left front wheel and the right front wheel are referred to as front wheels 210f. Further, the left rear wheel and the right rear wheel are referred to as rear wheels 210r. In this example, each of the wheels 210 can be turned freely, and accordingly, the cart 200 can be moved in any direction. In the present embodiment, at least one wheel 210 is stopped by the stopper 106, the detector 108 detects a front wheel 210f, and accordingly, the charging is started.

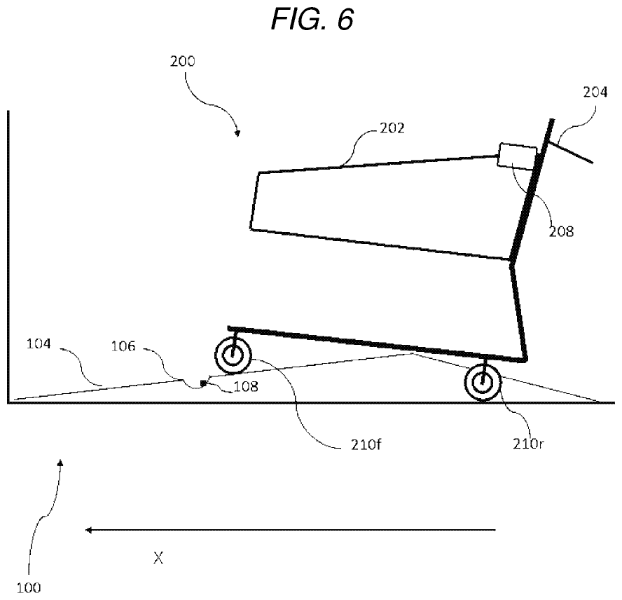

FIG. 6 illustrates a side view of the cart power supply equipment 100 and the cart 200. For explanatory convenience, some parts or aspects unnecessary for understanding the present description will not be further explained. First, when storing a cart 200 in the cart power supply equipment 100, the user makes the cart 200 advance into the frame 102 such that the front wheels 210f advance on the slope 104. The user pushes the cart until the front wheels 210f pass the vertex T of the slope 104 to advance on the first slope S1. When a front wheel 210f exceeds the vertex T of the slope 104, the cart 200 starts to descend the second slope S2 under its own weight (more particularly, the combined weight of the main body of the cart 200, the display 204, the battery 206, the power receiver 208 and the like). Thereafter, when a front wheel 210f reaches the stopper 106, the advance of the cart 200 is stopped. In other words, the user simply pushes the cart 200 until front wheels 210f of the cart 200 exceed the vertex T of the slope 104 and then releases the grip on the cart 200, and accordingly, the cart 200 advances in the cart power supply equipment 100 and stops at the charging position. In addition, the detector 108 detects the front wheels 210f of the cart 200 and then transmits a signal indicating that the cart 200 is at the charging position to the controller 114. Thereafter, the controller 114 starts the non-contact (wireless) charging processing.

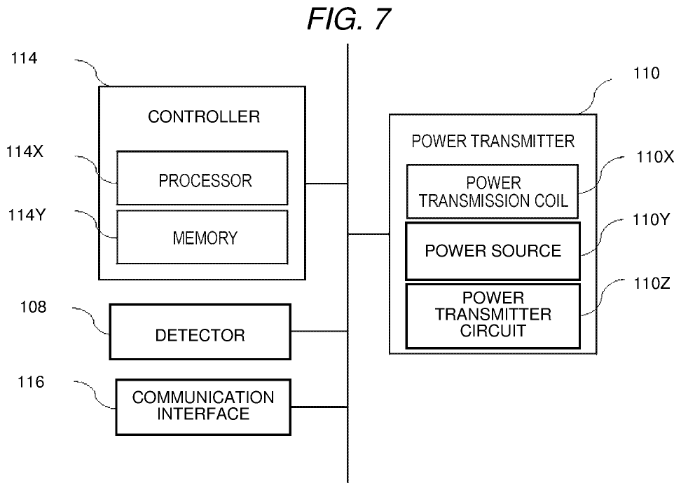

Next, the hardware configuration of the cart power supply equipment 100 will be described with reference to FIG. 7. The description of aspects of the already described may be omitted. The cart power supply equipment 100 includes the controller 114, the detector 108, a communication interface 116, and the power transmitter 110.

The controller 114 includes a processor 114X, which may be a central processing unit (CPU) or a micro processing unit (MPU), and a memory 114Y. For example, the memory 114Y is a semiconductor memory, and includes a read only memory (ROM) for storing various control programs, and a random access memory (RAM) for providing a temporary work region to the processor 114X. The controller 114 controls each unit of the cart power supply equipment 100 based on various control programs and the like stored in the ROM.

The communication interface 116 includes an interface that communicates with a communication interface 208d of the cart 200, which will be described below, by a wireless communication interface using radio waves or infrared rays, or a communication interface, such as load modulation of carrier waves used for power transmission. The communication interface 116 communicates with the communication interface 208d of the cart 200 to obtain the power value information received by the power receiver 208, information on the charging status, and the like, and transmit this information to the controller 114. For example, the controller 114 controls the electric power transmitted from the power transmitter circuit 110Z based on a request sent from the power receiver 208, which will be described below, via the communication interface 116. Furthermore, the controller 114 controls the power transmitter circuit 110Z to stop the power transmission when the electric power to be transmitted exceeds a threshold value Th stored in the memory 114B.

The power transmitter 110 includes a power transmission coil 110X, a power source 110Y, and the power transmitter circuit 1102. A high frequency magnetic flux is generated by making a high frequency current generated by the power transmitter circuit 1102 flow to the power transmission coil 110X. The electric power for charging is generated in a power receiving coil 208a using the magnetic flux. The power source 110Y is supplied with power from an AC adapter or the like from outside the power transmitter 110, and converts the power into a voltage appropriate for each unit in the power transmitter 110. The power transmitter circuit 110Z includes an oscillating unit that generates a high frequency signal and a power amplification unit (not separately illustrated) that amplifies the generated high frequency signal. In this manner, a DC voltage supplied from the power source 110Y is converted into an alternating current, high frequency power is generated, and the electric power is transmitted from the power transmission coil 110X.

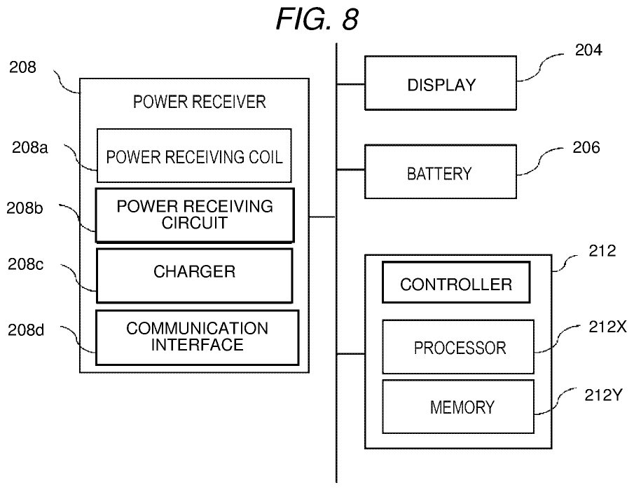

Next, the hardware configuration of the cart 200 will be described with reference to FIG. 8. In addition, the configuration that is already described will not be described. The cart 200 includes a controller 212, a display 204, the battery 206, and the power receiver 208.

The power receiver 208 includes the power receiving coil 208a, a power receiving circuit 208b, a charger 208c, and the communication interface 208d.

The power receiving coil 208a receives the electric power by magnetic field coupling, such as electromagnetic induction by the magnetic flux generated from the power transmission coil 110X.

The power receiving circuit 208b includes a rectifying unit that rectifies the electric power (AC current) obtained by the power receiving coil 208a from the power transmission coil 110X into a direct current, and a DC/DC unit that converts voltage. The power receiving circuit 208b converts the DC voltage generated by the rectifying unit into a DC voltage appropriate for the operation of the charger 208c, and supplies the appropriate DC voltage to the charger 208c.

The charger 208c generates a voltage and current appropriate for charging the battery 206, and thus charges the battery 206. Hereinafter, the current supplied from the charger 208c to the battery 206 is referred to as a charging current.

The communication interface 208d includes an interface that communicates with the communication interface 116 of the power transmitter 110 by a wireless communication interface using radio waves or infrared rays, or a communication interface, such as load modulation of carrier waves used for power transmission.

The controller 212 includes a processor 212X, which is an arithmetic unit, and a memory 212Y, which is a storage device. For example, the controller 212 measures the voltage output from the power receiving circuit 208b, and requests the power transmitter 110 to adjust the transmitted power via the communication interface 116 such that the voltage value required by the charger 208c can be obtained. The controller 212 sets the current value of the charging current with respect to the charger 208c, and can detect the actual charging current value. Therefore, when there is a difference between the set charging current value and the actual charging current value, it is also possible to request the power transmitter 110 to adjust the transmitted power via the communication interface 116. Although the controller 212 sets the charging current so as to charge the battery 206, when it is detected that the charging current has become zero, it can be determined that the power transmitter 110 has stopped the power transmission.

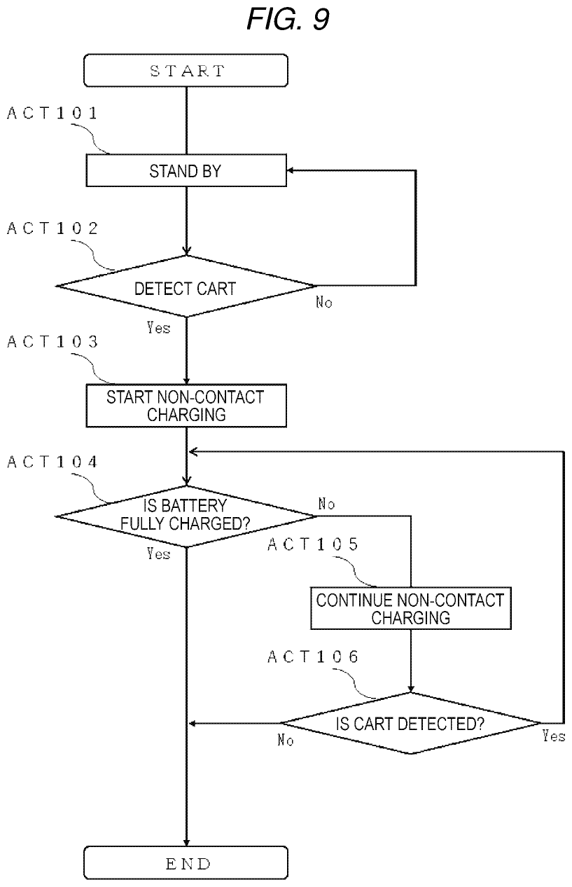

FIG. 9 is a flowchart illustrating non-contact charging processing between the cart power supply equipment 100 and the cart 200 in the embodiment.

First, the controller 114 is in a standby state (ACT 101), and the controller 114 stands by until receiving a signal indicating that the cart 200 is detected from the detector 108 (NO in ACT 102). When receiving the signal indicating that the cart 200 is detected from the detector 108 (YES in ACT 102), the controller 114 starts the non-contact power supply and charges the battery 206 (ACT 103). Thereafter, the controller 114 continues charging the battery 206, and when a signal indicating that the battery 206 is fully charged is received from the power receiver 208 (YES in ACT 104), the controller 114 stops the non-contact power supply and ends a series of charging processing.

When the battery 206 is not fully charged (NO in ACT 104), the controller 114 continues the power supply (ACT 105). When the detector 108 no longer detects the cart 200 (NO in ACT 106), the controller 114 determines that the cart 200 is away from the charging position, and ends of charging processing. When the detector 108 continues to detect the cart 200 (YES in ACT 106), the controller 114 repeats the processing of ACT 104 to ACT 106 until the battery 206 is fully charged.

Above, the cart power supply equipment 100 according to the embodiment can start charging the cart 200 by guiding the cart 200 to a position with excellent charging efficiency even when the user does not appropriately convey the cart 200 to the charging position in the cart power supply equipment 100.

### Second Embodiment

Next, a second embodiment will be described with reference to the drawings.

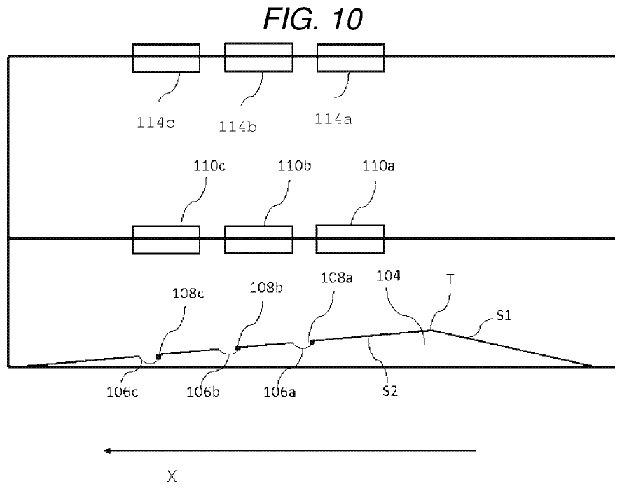

FIG. 10 illustrates a side plan view of the cart power supply equipment 100 according to the second embodiment. The slope 104 of the second embodiment has a plurality of stoppers 106a, 106b, and 106c. In the following description, although three different stoppers 106 are provided, the embodiments are not limited thereto. The number of stoppers 106 may be two, four, or more than four.

A power transmitter 110 is provided corresponding to each stopper 106. For example, in FIG. 10, since three stoppers 106 are provided, three power transmitters 110 are also provided. Each of the power transmitters 110A, 110B, and 110C is provided at a position facing a power receiver 208 of different carts 200 stored in the cart power supply equipment 100. Accordingly, a plurality of carts 200 stopped at a charging position by one of the stoppers 106 can be simultaneously charged while stored in the cart power supply equipment 100.

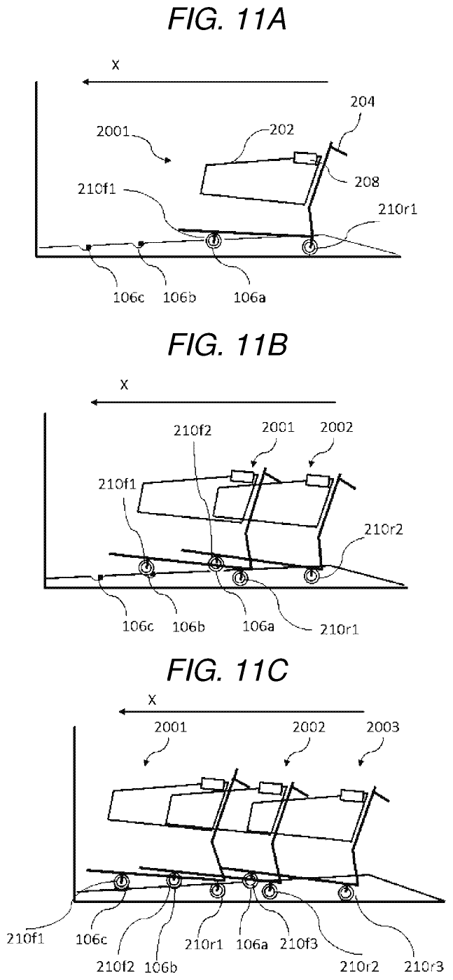

FIGS. 11A to 11C illustrate plan views of the cart power supply equipment 100 in a state where one or more carts 200 are stored therein. In the following description, the first cart is a cart 2001, the second cart is a cart 2002, and the third cart is a cart 2003. Further, a front wheel of the cart 2001 is referred to as a front wheel 210f1, and a rear wheel of the cart 2001 is referred to as a rear wheel 210r1 . Similarly, a front wheel of the cart 2002 is referred to as a front wheel 210f2, a rear wheel of the cart 2002 is referred to as a rear wheel 210r2. Likewise, a front wheel of the cart 2003 is referred to as a front wheel 210f3, and a rear wheel of the cart 2003 is referred to as a rear wheel 210r3.

FIG. 11A illustrates a plan view of the cart power supply equipment 100 in a state where one cart 2001 is stored therein. In the cart power supply equipment 100 of this embodiment, similarly to the first embodiment, when the front wheel 210f1 of the cart 2001 exceeds over the vertex T of the slope 104, the cart 2001 advances along the slope 104 under its own weight. When the front wheel 210f1 of the cart 2001 reaches the first stopper 106a, the advance of the cart 2001 is stopped. In other words, the cart 2001 does not yet advance to the lowermost position in the cart power supply equipment 100, but rather stops near the entrance of the cart power supply equipment 100.

FIG. 11B illustrates a plan view of the cart power supply equipment 100 in a state where two carts 2001 and 2002 are stored therein. When the second cart 2002 is added to the car power supply equipment 100, the first cart 2001 is already stopped near the entrance (as illustrated in FIG. 11A). Therefore, when the user stores the second cart 2002, the second cart 2002 comes into contact with the first cart 2001. The user applies a force to the second cart 2002 until the front wheel 210f1 of the first cart 2001 is pushed out from the stopper 106a. As a result, the first cart 2001 advances in the X direction under its own weight after the front wheel 210f1 is pushed out from the stopper 106a and stops at the stopper 106b. The second cart 2002 advances in the X direction under its own weight and stops at the stopper 106a.

FIG. 11C illustrates a plan view of the cart power supply equipment 100 in a state where three carts 2001, 2002, and 2003 are stored therein. When the third cart 2003 is added, the second cart 2002 is already stopped near the entrance. Therefore, when the user stores the third cart 2003, a part of the third cart 2003 comes into contact with the second cart 2002. The user must apply a force to the third cart 2003 until the front wheel 210f1 of the first cart 2001 and the front wheel 210f2 of the second cart 2002 are pushed out from the stopper 106. As a result, the first cart 2001 advances in the X direction under its own weight after the front wheel 210f1 is pushed out from the stopper 106b and stops at the stopper 106c. Similarly, the second cart 2002 advances in the X direction under its own weight after the front wheel 210 is pushed out from the stopper 106a and stops at the stopper 106b. The third cart 2003 advances in the X direction under its own weight and stops at the stopper 106a.

In the description above, the user may need to push an added cart 200 until a previously stored cart 200 is pushed out from the stopper 106, but the present disclosure is not limited thereto. In some examples, when a front wheel 210f exceeds the vertex T, and the newly added cart 200 may advance by its own weight until it come into contact with the already stored cart(s) 200 to push out a front (already stored) cart 200 from its present position to the next available position.

In the example above, the carts 200 are stopped sequentially from the stopper 106a on the front side in the advancing direction X to the next stopper 106b, and then the next stopper 106c, but the embodiments are not limited to this configuration. For example, the first cart 2001 may stop at the stopper 106b depending on the force applied by the user. In addition, it is contemplated that the first cart 2001 could be stopped at lowest position (the stopper 106c) and the next cart 2002 would be stopped at a higher position (e.g., the stopper 106a). Even in this case, based on the detection result of the detector 108, the power transmitters 110C and 110A are driven to start the non-contact charging with the power receivers 208 of the two carts 200.

In this manner, a plurality of carts 200 stop at a charging position in the cart power supply equipment 100. As described above, the cart power supply equipment 100 is provided with the power transmitters 110 so as to correspond to the stoppers 106. Therefore, each of the carts 200 can charge via a power receiver 208 from a power transmitter 110 that corresponds to the stopper 106 which has stopped by itself.

By the above-described processing, when the battery 206 of each of the carts 200 is fully charged, or when the detector 108 does not detect the cart 200, the controller 114 stops the non-contact power supply and ends the series of charging processing.

The cart power supply equipment 100 according to an embodiment can more simply start charging since carts can be guided to a position with excellent charging efficiency even when the user does not exactly convey the cart 200 to the appropriate charging position in the cart power supply equipment 100. In addition, even when the carts 200 are stacked and stored, the non-contact charging is still possible, and thus, it is possible to charge the battery 206 of the multiple carts (e.g., carts 2001, 2002, and 2003) without additional labor and time.

In addition, although the configuration in which the numbers of the stoppers 106, the detectors 108, and the power transmitters 110 are equal to each other has been described as an example, the present disclosure is not limited thereto. For example, only one stopper 106 may be provided, and two or more detectors 108 and two or more power transmitters 110 may be provided. In addition, the number of stoppers 106 and the number of power transmitters 110 can be varied in any manner.

For example, when the first cart 2001 advances on the slope 104, the first cart 2001 stops at the charging position by the stopper 106. When the second cart 2002 advances on the slope 104, a part of the second cart 2002 overlaps the first cart 2001 and stops. When the third cart 2003 advances on the slope 104, a part of the third cart 2003 overlaps the second cart 2002 and stops. In other words, the stop positions of the second cart 2002 and the third cart 2003 are necessarily determined by the first cart 2001. Accordingly, the detector 108 or the power transmitter 110 can be provided at the stop position of the second cart 2002 and/or the stop position of the third cart 2003 without need for additional stopper (s) 106.

An initial cart stored in the above-described configuration advances to a charging position under its own weight. In other words, since the initial or prior cart does not stop near the entrance of the cart power supply equipment 100, when another user stores another cart without pushing the already carts forward, the added cart is simply conveyed to the next available charging position and the charging is started.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cart power supply equipment, comprising:
a frame providing a cart storage region;
a guide including an uphill slope portion having an uphill slope along a cart guide direction to the cart storage region and a downhill slope portion having a downhill slope in the cart guide direction, the downhill slope portion being downstream of the uphill slope portion along the cart guide direction;
a first stopper configured to stop a cart at a stop position on the downhill slope portion of the guide;
a detector configured to detect that the cart is at the stop position;
a power transmitter configured to transmit power for charging in a non-contact manner; and
a controller configured to control the power transmitter to start transmitting the power when the detector detects that the cart is at the stop position.

2. The cart power supply equipment according to claim 1, wherein the first stopper is a bump provided on the downhill slope portion.

3. The cart power supply equipment according to claim 1, wherein a length of the downhill slope portion in the cart guide direction is greater than a length of the uphill slope portion in the cart guide direction.

4. The cart power supply equipment according to claim 1, wherein the downhill slope portion includes a cartwheel guide along the cart guide direction.

5. The cart power supply equipment according to claim 1, wherein the uphill slope portion includes a cart wheel guide along the cart guide direction.

6. The cart power supply equipment according to claim 1, wherein the detector includes a mechanical sensor configured to be operated by a wheel of a cart when the cart is at the stop position.

7. The cart power supply equipment according to claim 1, wherein the detector includes an optical sensor configured detect a wheel of a cart when the cart is at the stop position.

8. The cart power supply equipment according to claim 1, further comprising:
a second stopper configured to stop a cart on the downhill slope portion at a second stop position downhill of the first stop position in the cart guide direction;
a second detector configured to detect that the cart is at the second stop position; and
a second power transmitter configured to transmit power for charging in a non-contact manner, wherein
the controller is further configured to control the second power transmitter to start transmitting the power when the second detector detects that the cart is at the second stop position.

9. The cart power supply equipment according to claim 8, further comprising:
a third stopper configured to stop a cart on the downhill slope portion at a third stop position downhill of the second stop position in the cart guide direction;
a third detector configured to detect that the cart is at the third stop position; and
a third power transmitter configured to transmit power for charging in a non-contact manner, wherein
the controller is further configured to control the third power transmitter to start transmitting the power when the third detector detects that the cart is at the third stop position.

10. The cart power supply equipment according to claim 1, wherein the controller is further configured to determine a charge state of the cart at the stop position, and control the power transmitter to stop transmitting power upon determining the charge state of the cart at the stop position is a fully charged state.

11. A cart storage system, comprising:
a cart power supply equipment comprising:
a frame providing a cart storage region for a plurality of carts, each of the carts including a battery and a power receiver configured to receive electric power in a non-contact manner for charging the battery;
a guide including an uphill slope portion having an uphill slope along a cart guide direction to the cart storage region and a downhill slope portion having a downhill slope in the cart guide direction, the downhill slope portion being downstream of the uphill slope portion along the cart guide direction;
a first stopper configured to stop a cart at a first stop position on the downhill slope portion of the guide;
a second stopper configured to stop a cart at a second stop position on the downhill slope portion of the guide, wherein the first stop position is downstream relative to the second stop position along the cart guide direction;
a first power transmitter configured to transmit first power for charging in a non-contact manner when a cart is stopped at the first stop position; and
a second power transmitter configured to transmit second power for charging in a non-contact manner when a cart is stopped at the second stop position.

12. The cart system according to claim 11, wherein each of the first stopper and the second stopper is a bump on the downhill slope portion of the guide.

13. The cart storage system according to claim 11, wherein a length of the downhill slope portion in the cart guide direction is greater than a length of the uphill slope portion in the cart guide direction.

14. The cart storage system according to claim 11, wherein the downhill slope portion includes a cart wheel guide along the cart guide direction.

15. The cart storage system according to claim 11, wherein the uphill slope portion includes a cart wheel guide along the cart guide direction.

16. The cart storage system according to claim 11, further comprising:
a first detector configured to detect when a cart is at the first stop position; and
a second detector configured to detect when a cart is at the second stop position.

17. The cart storage system according to claim 16, wherein each of the first detector and the second detector includes a mechanical sensor configured to be operated by a wheel of a cart when the cart is at the respective one of the first and second stop positions.

18. The cart storage system according to claim 16, wherein each of the first detector and the second detector includes an optical sensor configured detect a wheel of a cart when the cart is at the respective one of the first and second stop positions.

19. The cart storage system according to claim 16, further comprising:
a controller configured to control when the first power transmitter and the second power transmitter are to transmit the first power and the second power, respectively, based on detection signals from the first and second detectors.

20. The cart storage system according to claim 19, wherein the controller is further configured to:
determine a charge state of a first cart at the first stop position, and a charge state of a second cart at the second stop position, and
control the first power transmitter to stop transmitting the first power upon determining the charge state of the first cart is a fully charge state, and the second power transmitter to stop transmitting the second power upon determining the charge state of the second cart is a fully charge state.
